(19) United States
(12) Patent Application Publication
(10) Pub. No.: US 2010/0276652 A1
(43) Pub. Date: Nov. 4, 2010

(54) Livestock Drop Guard

(76) Inventor: Travis D. Horton, Mountain Home, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/431,864

(22) Filed: Apr. 29, 2009

(51) Int. Cl. A01K 3/00

(52) U.S. Cl. 256/17

(57) ABSTRACT

A livestock guard. The livestock guard may include a rectangular base frame. Two vertical posts may be attached to the rectangular base frame. There may be a pivot bar centrally and longitudinally oriented within the rectangular base frame. There may be two livestock guard ramps within the rectangular base frame and pivotally attached to the pivot bar in such a way as to decline away from the pivot bar in opposite directions. The pivot bar may be supported at each end by a spring assembly housed in one of the vertical post members. The pivot bar may be supported in such a way as to normally rest at a predetermined height above the rectangular base frame and also in such a way as to be depressible to the height of the rectangular base frame when pressed under a certain weight.

### FIELD OF THE INVENTION

The present invention relates to an improved type of livestock guard.

### DESCRIPTION OF THE RELEVANT ART

Livestock are typically enclosed within a fenced area. Often the fenced area may be a very large area, and/or may include several adjacent fenced areas. In many cases there are multiple openings in various locations along the fence line to allow vehicles and equipment to pass through. One way of maintaining the continuity of the fence line at an opening in a fence and keeping livestock from crossing the fence line at the opening is to use a gate. However, in order to bring a vehicle through a gate, a driver must first get out of the vehicle, open the gate, pass through the gate, and close the gate.

Livestock guards, also called cattle guards, are another way of keeping livestock from crossing a fence line at an opening in a fence. Livestock guards typically comprise a number of bars each spaced a small distance (e.g., a few inches) apart from each other in a parallel manner. Cattle and many other animals are reluctant to cross over such spaced parallel bars, particularly if they are placed over a ditch or otherwise appear to be suspended over an empty space. Livestock guards have been known and in use for well over a hundred years, along fence openings, across roads, to prevent errant crossings over railroad tracks, and for similar purposes. Examples of various types of stock guards, including their general structure and operational features, can be found in U.S. Pat. Nos. 117,600; 1,529,460; 1,620,348; 322,399; and 4,609,184; among other documentation.

Recently, cattle guards have been proposed that implement a ramped design in order to create space between the livestock guard and the ground without requiring a ditch or trench to be cut. Examples of such designs are disclosed in U.S. Pat. No. 4,844,423, whose inventor is Linsey L. Combs, issued on Jul. 4, 1989; and in U.S. Pat. No. 5,419,537, whose inventor is Richard M. Thompson, issued on May 30, 1995. However, these designs have shown themselves in many cases to be particularly susceptible to wear and damage, even from normal intended usage. In particular, it is believed that the mechanism for attaching the two ramps in each of the above-referenced designs is responsible for many of the perceived problems. Accordingly, improvements in the field are desired.

### SUMMARY OF THE INVENTION

Embodiments are presented of an improved type of livestock guard. The livestock guard may include a substantially rectangular base frame, made of two opposing side members connected by two longitudinal end members. A hollow, tubular, vertical post member may be fixed to each of the opposing side members, in the middle of each side member. Each vertical post member may include a vertical guide slot cut into the lower end of the vertical post member and facing inward, i.e., facing toward the other vertical post member.

A longitudinally oriented central pivot bar may extend between the two tubular post members. The ends of the central pivot bar may extend into the vertical guide slots of the vertical post members. The central pivot bar may be supported at each end by a spring assembly in each vertical post member; the spring assemblies may support the central pivot bar, when at rest, at a certain height above the base frame.

Two ramps may be pivotally affixed to the central pivot bar: a first ramp may be pivotally fixed, for example by a plurality of hinges, to the central pivot bar and extend downward and outward to a first one of the end members, while a second ramp may be similarly fixed to the central pivot bar but on the opposite side, and may extend downward and outward to the other of the end members. The two ramps may be livestock guard ramps, each including a first side bar, a second side bar, and a plurality of equi-spaced longitudinal bars secured between the first side bar and the second side bar.

The end members may each include two guide members for maintaining the alignment of the two livestock guard ramps with the base frame. For example, the guide members may be smaller than the side bars of the ramps and may be aligned such that the side bars of the ramps may fit over the guide members. The side bars of the ramps may be able to slide along the guide members, e.g., if the ramps drop or rise up with the central pivot bar because a vehicle is passing over them.

The spring assemblies supporting the central pivot bar may be compressible; that is, if sufficient downward force is exerted on the central pivot bar, the spring assemblies may be compressed, allowing the central pivot bar and the two ramps attached to the central pivot bar to be depressed. For example, if the amount of force exceeds a predetermined threshold, the central pivot bar and the two ramps may be depressed to the level of the rectangular base frame. The spring assembly may then act to return to its unstressed position after the downward force on the central pivot bar is removed.

Each spring assembly may include a coil spring and a steel strap means of securing the coil spring to the central pivot bar. For example, the coil spring may, at its lower end, be fixed to the vertical post member in which it is housed. The upper end of the coil spring may be secured to the steel strap. The steel strap may extend downward from one side of the top of the coil spring to the central pivot bar, pass through the central pivot bar, and extend back up to the other side of the top of the coil spring. Thus, the steel strap means may transfer any downward force on the central pivot bar to the upper end of the coil spring, which may compress the coil spring; similarly, the steel strap may transfer the restoring force of the spring to the central pivot bar, returning it to its unstressed position, once the downward force on the central pivot bar is removed.

The action of the spring assemblies to return (and thereby return the central pivot bar and the two ramps) to their unstressed position may be dampened by a dampening apparatuses, such as pressure or dash-pot cylinders and connector rods. For example, there may be a dash-pot cylinder and connector rod within each vertical post member, connected between an end of the central pivot bar supported in a vertical post member and the upper end of that vertical post member. The dash-pot cylinders and connector rods may thus act to resist the spring assemblies' action, slowing their return to their at rest position.

The livestock guard described herein may provide a simple and effective way to prevent errant stock from crossing a gap in a fence. Several advantages of the apparatus are described below.

A first important advantage is that the livestock guard may provide an effective way of preventing stock (and other animals) from crossing a gap in a fence. The presence of spaced parallel bars (i.e., the guard ramps) combined with the ramped aspect of the livestock guard to make it particularly effective. For example, as the livestock guard ramps are oppositely inclined, an empty space is created between the guard ramps and the ground, without the need to dig a ditch or trench. As previously noted, the appearance of empty space beneath the parallel spaced bars of a livestock guard provides a significant deterrent to livestock which might otherwise be tempted to cross the livestock guard. A further benefit of the oppositely inclined guard ramps is that, due to the slope of the guard ramps, many animals may not be able to see the far guard ramp, e.g., they may only be able to see the guard ramp nearest them. As a result of this, the animals may be even more hesitant to attempt to cross or jump over the livestock guard.

A second important advantage is that the livestock guard may allow vehicles and other equipment to pass over it with minimal effort and without damaging the livestock guard. As the livestock guard ramps may drop to ground level when a vehicle passes over them and rise back up to inclined position once the vehicle has passed, the driver of the vehicle need not get out of the vehicle to cross the livestock guard. Additionally, because of the symmetric design and positioning of the guard ramps combined with the single central pivot bar, the livestock guard may be less susceptible to strain and damage (particularly to the hinges) than other designs.

An additional advantage is that the livestock guard may be easy to install. That is, because it does not require a ditch to be dug before being installed at a location at a fence line, a livestock guard may simply be placed and secured at that location. In this respect, the livestock guard may also be considered portable; thus, one could unsecure the livestock guard from the first location, move the livestock guard (e.g., with a light-duty hauling vehicle, such as a pick-up truck) to a second location and secure the livestock guard at the second location, without digging or filling in any ditches or trenches.

### BRIEF DESCRIPTION OF THE DRAWINGS

A better understanding of the present invention can be obtained when the following detailed description of the preferred embodiment is considered in conjunction with the following drawings, in which:

FIG. 1 depicts a top-down view of a livestock guard according to one embodiment of the present invention.

FIG. 2 depicts a quarter perspective view of a livestock guard according to one embodiment of the present invention.

FIG. 3 depicts a side view of a livestock guard according to one embodiment of the present invention.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

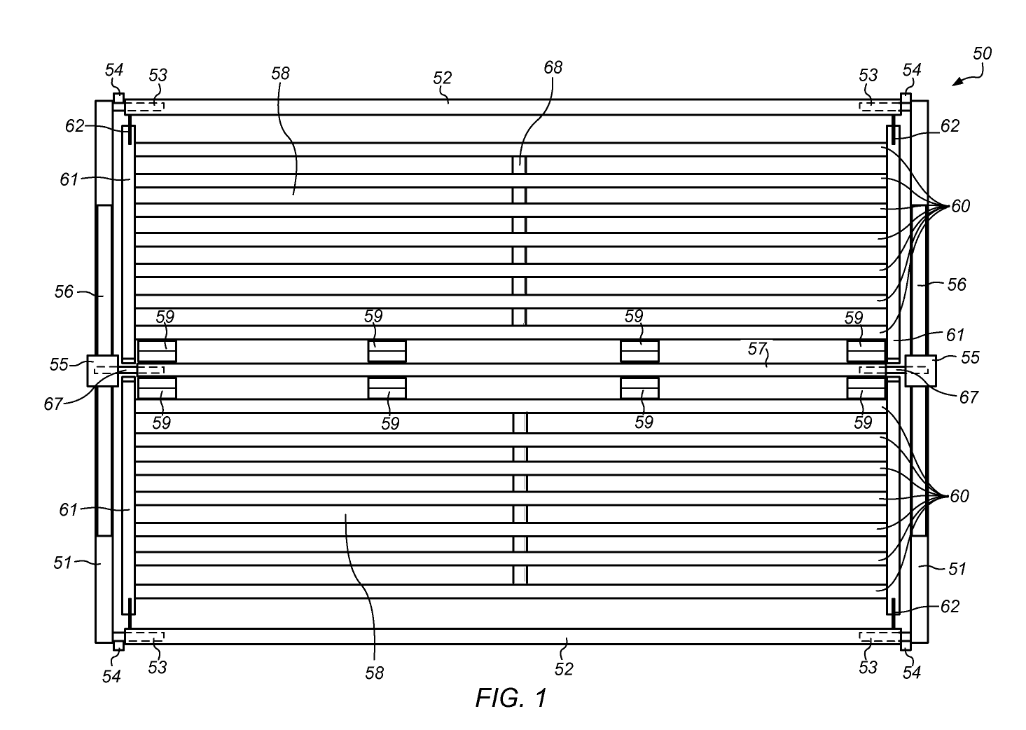

The present invention relates to an improved type of livestock guard, as shown according to one embodiment in FIGS. 1-3. The livestock guard 50 may include a substantially rectangular base frame, two vertical posts, a central pivot bar, and two livestock guard ramps. The livestock guard may further include a spring assembly housed in each vertical post for supporting the central pivot bar and the two livestock guard ramps.

Referring first to FIG. 1, in which a top-down view of an embodiment of the invention is presented, the rectangular base frame may include two side members 51 and two end members 52. The side members 51 and the end members 52 may be tubes or bars, e.g., in one embodiment they may be 2.5″ square steel tubing. The side members 51 and the end members 52 may be connected by any conventional securing means, such as welding or other conventional fasteners. In a preferred embodiment, the rectangular base frame may be 8′×14′; however, other dimensions (e.g., smaller livestock guards to allow all terrain vehicles (ATVs) or other small vehicles, or larger livestock guards to allow larger farm equipment or other large vehicles, among other possibilities) are also possible.

In one embodiment, the side members 51 may include a smaller connecting member 53 at each end, e.g., a metal dowel or rod welded onto each end of the side members 51, which may be operable to fit inside the end members 52 as a means of securing the end members 52 to the side members 51, thereby fitting them together as a substantially rectangular base frame. In a preferred embodiment, the connecting members 53 may be 2″ square steel tubing. In some embodiments there may be extenders 54, e.g., metal extenders, on the side bars 51 and the end bars 52, located such that when the side members 51 and the end members 52 are properly fit together, the extenders 54 may be aligned in such a way that it is possible to lock or otherwise secure them together. Thus in some embodiments, the rectangular base frame may be assembled or disassembled as desired, simply by sliding the connecting members 52 on the side members 51 into the end members 52 together and locking them together at the extenders 54, or by unlocking them and sliding them apart. It should be noted that other embodiments, e.g., in which the rectangular base frame is permanently connected, are also possible.

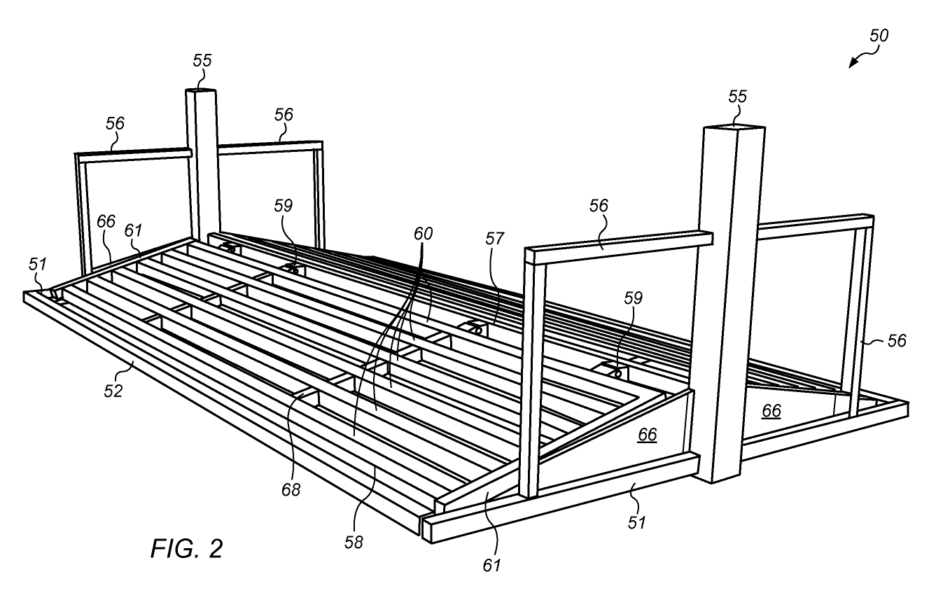

Referring now to FIG. 2, in which a quarter perspective view of an embodiment of the invention is presented, each side member 51 may have a vertical post member 55 attached thereto. Each vertical post member 55 may be a tubular post member. Here the term “tubular” post member refers to a post member that is at least partially hollow, in order to house one or more other components (such as a spring assembly, as described herein) of the livestock guard within it. In some embodiments, each vertical post member 55 may be substantially larger than the other members of the invention, for example, in the preferred embodiment the vertical posts may be 6″ steel square tubing with 0.188″ thick walls. The vertical post members may be approximately 4′ high in the preferred embodiment, although any number of other heights are also possible. Each vertical post member 55 may include a centrally facing vertical guide slot. The vertical guide slots may face inward (e.g., towards each other) and be composed at the bottom of each vertical post member, extending, e.g., 10″, 12″, 14″, or any number of inches, as desired, above the rectangular base frame.

There may further be a side rail 56 connected to each side member 51 and each vertical post member 55. Each side rail 56 may include an angle bar, or tube, fixed (e.g., welded) to a side member 51 and to a vertical post member 55 on either side of each vertical post member 55. The side rails 56 may provide additional stability to the vertical post members 55. The side rails 56 may additionally act as guard rails, for example, to prevent any people or animals from accessing the livestock guard from the side, e.g., while a vehicle is passing over the livestock guard. In a preferred embodiment, the side rails 56 may each be made of 2″ steel square tubing, may rise 32″ above the rectangular base frame, and may extend 30″ from the vertical post members 55 parallel to the side bars. It should be noted that these dimensions are exemplary only, and other dimensions and materials are also possible.

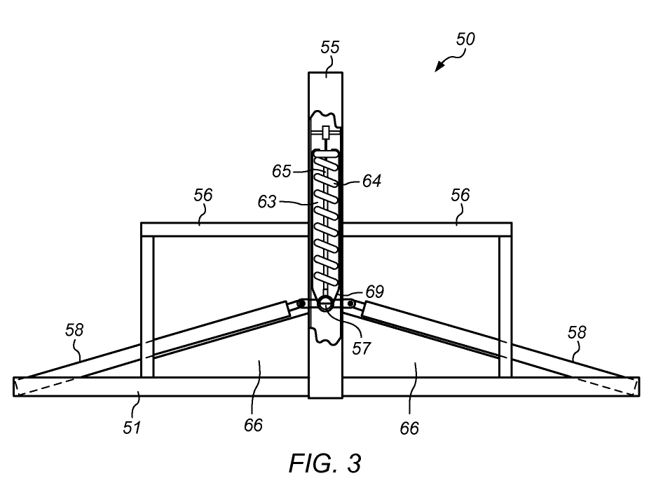

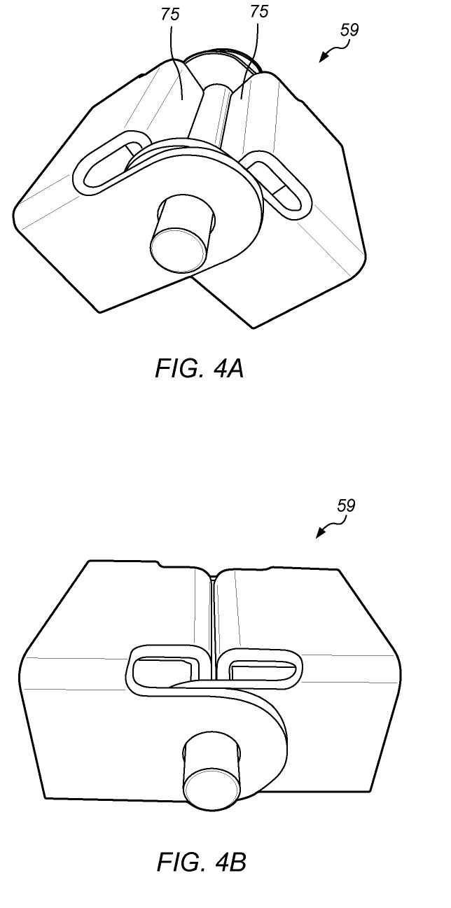

As shown in both FIGS. 1 and 2, the central pivot bar 57 may be longitudinally oriented and may extend between the two side members 51. The central pivot bar 57 may be of similar material construction as the side members 51 and end members 52; alternatively, the central pivot bar 57 may be larger, heavier, and/or thicker than the side members 51 and end members 52, for example, the central pivot bar 57 may be 2.5″ steel square tubing with 0.188″ walls. The central pivot bar 57 may, in some embodiments, include a bar 67 extending from each end of the central pivot bar 57. The central pivot bar 57 (or, in some embodiments, the bars 67 extending from the central pivot bar 57) may extend into (e.g., through the vertical guide slots) and be supported in the vertical post members 55. For example, the central pivot bar 57 may be supported in each vertical post member 55 by a spring assembly housed in that vertical post member 55. Such spring assemblies are described in more detail below with regard to FIG. 3.

The central pivot bar 57 may be supported, at rest, at a designated height above the rectangular base frame; for example, the central pivot bar 57 may rest at a height of 13″ above the base of the rectangular base frame. Alternatively, the central pivot bar 57 may rest at 8, 10, 16, 20, or any number of inches above the rectangular base frame, as desired. The central pivot bar 57 may be supported at or near the top of each vertical guide slot in each vertical post member 55, and may be aligned with the vertical guide slots in each vertical post member 55 such that the ends of the central pivot bar 57 may drop and rise unobstructed by the vertical post member 55.

The central pivot bar 57 may be pivotally affixed to two livestock guard ramps 58. For example, as shown in FIG. 1, there may be a plurality of hinges 59 pivotally fixing each livestock guard ramp 58 to the central pivot bar 57. There may be four hinges attaching each livestock guard ramp 58 to the central pivot bar 57, as shown, or there may be two, three, or any number of hinges as desired. Each hinge may be welded or otherwise fixed to both the central pivot bar 57 and one of the livestock guard ramps 58. In a preferred embodiment, the hinges may be of or similar to the design shown in FIGS. 4A and 4B, although various other embodiments may include different types of hinges.

The hinges 59 shown in FIGS. 4A and 4B may be 5″ (or other sized) one-way hinges (such as one way box hinges, so named for their box-like shape). FIG. 4A shows a hinge 59 partially hinged, while FIG. 4B shows the hinge 59 flat, i.e., at 180 degrees. There may be lips 75 to prevent the hinges from pivoting past 180 degrees, i.e., the hinges may be one-way hinges. The lips 75, by preventing two-way pivoting of the hinges, may provide extra rigidity to the design; that is, when downward force is exerted on a livestock guard ramp 58, the hinges connecting that livestock guard ramp 59 to the central pivot bar 57 may, once they rotate to 180 degrees, instead of rotating past 180 degrees (which could result in additional stress on the pivotal connection and create a bigger ‘bump’ for a vehicle crossing the central pivot bar 57), act as a rigid connection to the central pivot bar 57, thereby transferring some of the downward force on the livestock guard ramp 59 to the central pivot bar 57.

Each livestock guard ramp 58 may thus be pivotally affixed to the central pivot bar, and may (at rest) extend at a downward angle (e.g., may decline) toward an end member 52. The livestock guard ramps 58 may be pivotally affixed to the central pivot bar 57 on opposite sides of the central pivot bar 57, as shown, in such a way as to extend symmetrically in opposite directions toward the opposing end members 52.

Each of the livestock guard ramps 58 may include a plurality of equi-spaced longitudinal bars 60 extending between and fixed to two side bars 61. Thus in one embodiment, the plurality of equi-spaced longitudinal bars 60 might include 6 bars, each made of 2.5″ steel square tubing with 0.120″ inch walls, each spaced 4.25″ inches apart from the next, and fixed to the two side bars by welding. Each livestock guard ramp 58 may further include one or more additional brace members 68 in addition to the side bars 61 and located parallel to and between the side bars 61, which may connect the equi-spaced longitudinal bars 60; this may provide additional support for and help maintain the spacing of the equi-spaced longitudinal bars 60. It should be noted that other spacings and other types of bars are also possible, e.g., depending on what type of animals the livestock guard is primarily directed to. In some embodiments, the equi-spaced longitudinal bars 60 may be of the same material construction as the longitudinally oriented central pivot bar 57; in other embodiments, the central pivot bar 57 may be larger, heavier, and/or thicker than the equi-spaced longitudinal bars 60. For example, in the preferred embodiment, the central pivot bar 57 and the equi-spaced longitudinal bars 60 may both be 2.5″ steel square tubing, but the central pivot bar 57 may have 0.188″ thick walls, while the equi-spaced longitudinal bars may have 0.120″ thick walls.

There may be a mechanism to support and/or maintain the alignment of the two livestock guard ramps 58 with the rectangular base frame. For example, in some embodiments, each end member 52 may include two guide members 62. The guide members 62 may be of a smaller gauge than the side bars 61 of the livestock guard ramps 58, and may be fixed to the end members 52, e.g., by welding or other securing means. In the preferred embodiment, the guide members 62 may each be 6″ long and may be 1″ solid steel square rods, although other materials and/or dimensions are also possible. The guide members 62 may be located on the end members 52 proximate the side bars 61; in other words, each guide member 62 may align with a side bar 61 and fit inside it in such a way that when all the side bars 61 are fitted over guide members 62, the livestock guard ramps 58 may remain substantially aligned with the rectangular base frame, even when the central pivot bar 57 and the livestock guard ramps 58 are depressed under a weight, such as when a vehicle passes over the livestock guard 50.

Referring now to FIG. 3, in which a cut-away side view of an embodiment of the invention is presented, there may be a spring assembly 63 housed in each vertical post member. Each spring assembly may include a coil spring 64, e.g., a compression spring. The coil spring 64 may be fixed to the vertical post member in which it is housed, e.g., it may be supported by a collar within the vertical post member 55 at a certain height above the rectangular base frame; for example, the lower end of the coil spring 64 may be supported at approximately the same height as the central pivot bar 57. According to the preferred embodiment, each coil spring may be approximately 40″ long and may be an oil tempered coil spring with a 4.75″ outside diameter and a 0.468″ size spring, although other spring types, lengths, and/or sizes are also possible. The upper end of the coil spring 64 may be attached to the upper end of a steel strap 69 whose lower end is attached to the central pivot bar 57. In one embodiment, the steel strap 69 may pass through the end of the central pivot bar 57, e.g., the steel strap 69 may be U shaped, attaching to the top of the coil spring 64 at each end of the U and passing through the central pivot bar 57 at the bottom of the U. Thus, the steel strap 69 (as part of the spring assembly 63 in each vertical post member 55) may support each end of the central pivot bar 57 in that respective vertical post member 55.

In particular, the central pivot bar 57 may be supported by the spring assembly 63 such that downward force on the central pivot bar 57 is transferred to the coil springs 64 in the spring assemblies 63 housed in each vertical post member 55. Thus, sufficient downward force on the central pivot bar 57 (as for example might be produced by the weight of a vehicle passing over the livestock guard) may compress the coil spring 64, and the central pivot bar 57 together with the two livestock guard ramps 58 pivotally attached to the central pivot bar 57 may be depressed approximately to the level of the rectangular base frame. It should be noted that the amount of force required to depress the central pivot bar 57 and the two livestock guard ramps 58 to the level of the rectangular base frame may be a predetermined threshold of force, e.g., determined by the compressibility of the coil springs 64; that is, the coil springs 64 may be selected in order to configure the livestock guard 50 for the intended loads (e.g., vehicle weights) which the livestock guard 50 is expected to handle. Thus, the livestock guard 50 may drop to permit a vehicle (or other heavy objects such as farm equipment) to pass over it, and rise back up once the vehicle has passed off of the livestock guard 50.

Some embodiments may further include a damping apparatus 65 as part of the livestock guard 50, in order to slow the coil spring's 64 response and keep the livestock guard from rising up too quickly (e.g., between the front wheels of a vehicle passing over the central pivot bar 57 and the back wheels of the vehicle passing over the central pivot bar 57, potentially damaging the underside of or otherwise hindering the vehicle). In one embodiment the damping apparatus 65 may include a dashpot type of cylinder attached to each end of the central pivot bar 57 and extending upward through the middle of the coil spring. The dashpot cylinder may include an actuator or connector rod extending upwards from the dashpot cylinder and attached to the vertical post member, for example, the connector rod might attach to the vertical post member near or at the top of the inside of the vertical post member. In a preferred embodiment, the connector rod may be attached approximately 6″ down from the top of the vertical post member, and may attach to a pin or bar connected to the vertical post member, as shown in FIG. 3. The dashpot cylinder may be a single-orifice dashpot cylinder, although other types of cylinders are also possible. In one embodiment, the cylinder apparatus may be 23.75″ long when retracted, with a 14.75″ stroke such that when extended, the cylinder apparatus may be 38.5″ long. Thus when the central pivot bar 57 is depressed under a downward force, the connector rod may extend from the dashpot cylinder; when the downward force on the central pivot bar 57 is released and the coil spring exerts a restoring force, the dashpot cylinder and connector rod may exert resistance, delaying the return of the apparatus to its at-rest position and potentially preventing any possible damage to the underside of, or hindrance to, a vehicle passing over it.

Some embodiments of the livestock guard 50 may further include four guard sheets 66 as shown in FIGS. 2 and 3. These guard sheets 66 may be triangular sheets of metal, e.g., 0.125″ flat steel plates, fixed (e.g., welded) to the side members 51 and the vertical post members 55. The guard sheets 66 may be shaped such that each triangle has one corner approximately where a side member 51 connects to an end member 52, one corner approximately where that side member 51 connects to the vertical post member 55 centrally fixed to that side member 51, and one corner on that vertical post member 55 approximately at the height of the resting position of the central pivot bar 57. Alternatively, the corner extending to the end member 52 may be “cut off” such that the guard sheet 66 does not extend past the guard rail 56. Thus, the guard sheets 66 may form a barrier between the side of the livestock guard 50 and the area underneath the livestock guard ramps 58 and the central pivot bar 57. This may be desirable in order to avoid accidental placement of any objects (such as a person's feet) under the livestock guard ramps 58, which could result in damage or injury to such objects if a vehicle passed over the livestock guard ramp while the objects were underneath it.

It is believed that the livestock guard disclosed herein includes a number of advantages over previous cattle guards. In particular, the use of a single central pivot bar, with symmetric livestock guard ramps pivotally attached on either side, represents a significant improvement over prior art designs.

For example, the use of a single central pivot bar decreases the lateral distance between hinges, over, for example, a design using a central pivot ramp with multiple longitudinal bars. Additionally, the use of one-way hinges may further increase this advantage. Both of these features act to reduce the strain on the hinges and the apparatus as a whole, which would otherwise be subject to rocking as a vehicle passed over it. This extra strain in prior art designs including central pivot ramps with multiple longitudinal bars is believed to increase the likelihood of mechanical failure, particularly of the hinges. Thus, the use of a single central pivot bar, especially when coupled with the use of one-way hinges, which reduce this unnecessary stress, represents an improvement over this type of prior art design.

Additionally, use of a central pivot bar with symmetric livestock guard ramps represents an improvement over prior art solutions using asymmetric livestock guard ramps, e.g., where one guard ramp includes a lead bar which is supported by a spring assembly and a second guard ramp pivotally attaches to that guard ramp. Among the reasons for this include the simpler manufacture and assembly of the symmetrical design, and the simpler, smoother, direct up-and-down path of the central pivot bar when dropping and rising, as compared to the more complex mechanics involved in the dropping and rising of a lead bar that is part of a sloping guard ramp.

Thus, in addition to providing an effective and easy to install livestock guard, the livestock guard disclosed herein may represent a more durable and lasting type of ramped livestock guard apparatus than previously known in the art.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A livestock guard, comprising:
a substantially rectangular base frame, comprising two opposing side members connected at the ends by two longitudinal end members;
two tubular post members, wherein each tubular post member is fixed centrally and vertically to a respective one of the two side members, wherein each tubular post member comprises a centrally facing vertical guide slot;
a longitudinally oriented central pivot bar extending between the two tubular post members, wherein each end of the longitudinally oriented central pivot bar extends into and is supported in the centrally facing vertical guide slot of a respective one of the two tubular post members;
two spring assemblies, wherein each spring assembly is housed in a respective one of the two tubular post members, wherein each spring assembly is configured to support a respective end of the longitudinally oriented central pivot bar in a respective vertical guide slot of a respective tubular post member, wherein the two spring assemblies are configured to support the longitudinally oriented central pivot bar at a predetermined height above the base frame;
a first ramp pivotally affixed to the longitudinally oriented central pivot bar and extending to a first one of the two longitudinal end members; and
a second ramp pivotally affixed to the longitudinally oriented central pivot bar and extending to a second one of the two longitudinal end members.

2. The livestock guard of claim 1, further comprising
two dash-pot cylinders and connector rods, wherein each dash-pot cylinder and connector rod is comprised within a respective tubular post member, wherein each dash-pot cylinder and connector rod is connected between a respective supported end of the longitudinally oriented central pivot bar and an upper end of a respective one of the two tubular post members.

3. The livestock guard of claim 1,
wherein the spring assemblies supporting the ends of the longitudinally oriented pivot bar are compressible to allow the longitudinally oriented central pivot bar and the two ramps pivotally affixed to the longitudinally oriented central pivot bar to be depressed to the level of the rectangular base frame when an amount of downward force on the longitudinally oriented central pivot bar exceeds a predetermined threshold.

4. The livestock guard of claim 1,
wherein each of the first and second ramps comprises a first side bar, a second side bar, and a plurality of equi-spaced longitudinal bars, wherein each of the plurality of equi-spaced longitudinal bars is secured between the first side bar and the second side bar.

5. The livestock guard of claim 4,
wherein each longitudinal end member of the rectangular base frame comprises two guide members, wherein each guide member is of a smaller gauge than the side bars of the two ramps, wherein each guide member is affixed to the longitudinal end member at a position proximate a respective side bar of a respective one of the two ramps such that the guide member fits within the respective side bar, thereby keeping the two ramps substantially aligned with the rectangular base frame.

6. The livestock guard of claim 1,
wherein each of the first and second ramps comprises a first side bar, a second side bar, and a plurality of equi-spaced longitudinal bars, wherein each of the plurality of equi-spaced longitudinal bars is secured between the first side bar and the second side bar;
wherein the longitudinally oriented central pivot bar is heavier than each longitudinal bar of each ramp.

7. The livestock guard of claim 1, wherein each spring assembly comprises:
a coil spring, comprising an upper end and a lower end, wherein the lower end is secured to a respective one of the two tubular post members at a point proximate a respective end of the longitudinally oriented central pivot bar;
steel strap means secured through and supporting the respective end of the longitudinally oriented central pivot bar and extending upward, wherein the upper end of the steel strap means is secured to the upper end of the coil spring;
whereby downward force on the longitudinally oriented central pivot bar is transferred by the steel strap means to the upper end of the coil spring, thereby compressing the coil spring.

8. The livestock guard of claim 7, further comprising
two dash-pot cylinders and connector rods, wherein each dash-pot cylinder and connector rod is comprised within a respective tubular post member, wherein each dash-pot cylinder and connector rod is connected between a respective supported end of the longitudinally oriented central pivot bar and an upper end of a respective one of the two tubular post members;
wherein each dash-pot cylinder and connector rod is configured to delay recovery to an unstressed position of the respective coil spring housed in the same tubular post member as the dash-pot cylinder and connector rod.

9. The livestock guard of claim 1, wherein each of the first ramp and the second ramp is pivotally affixed to the longitudinally oriented central pivot bar by a plurality of one-way hinges.

10. A livestock guard apparatus, comprising:
a rectangular base member;
a pivot bar centrally and longitudinally oriented within the rectangular base member;
two livestock guard ramps confined within the rectangular base member;
first and second vertical post members fixed to the rectangular base member;
first and second spring biasing means respectively operatively housed within the first and second vertical post members;
means for connecting the pivot bar with the first and second spring biasing means; and
means for pivotally attaching the two livestock guard ramps to the pivot bar such that the livestock guard ramps decline away from the pivot bar in opposite directions.
